(19) United States
(12) Patent Application Publication
(10) Pub. No.: US 2004/0262546 A1
(43) Pub. Date: Dec. 30, 2004

(54) Radiation protection material, especially for use as radiation protection gloves

(76) Inventors: Axel Thiess, Duesseldorf (DE); A.K. Wong, Selangor (MY)

Correspondence Address: OLSON & HIERL, LTD., 36th Floor, 20 North Wacker Drive, Chicago, IL, 60606, US

(21) Appl. No.: 10/603,305

(22) Filed: Jun. 25, 2003

(51) Int. Cl. G21F 1/00; B32B 25/04; G21F 5/00

(52) U.S. Cl. 250/515.1; 428/492

(57) ABSTRACT

Proposed is a radiation protection material, especially for use as radiation protection gloves, comprising at least one layer of a matrix material containing natural or synthetic rubber in which, to attenuate the radiation intensity of scattered radiation, radiation absorbing particles are distributed, whereby at least one layer is formed by dipping a pattern in a latex compound of matrix material followed by vulcanisation of the matrix material on the pattern, where the radiation protection material is lead-free and may comprise several successively formed layers and the matrix material compound comprises about 20 to 40% by weight, and more preferably about 33% by weight dry rubber and about 60 to 80% by weight, preferably about 67% by weight of the radiation absorbing particles. This polymeric material may also comprise a small amount of a cellulose derivative in the range of about 0.1 to 0.4%, preferably about 0.25% by dry weight.

### TECHNICAL FIELD OF THE INVENTION

The invention concerns a radiation protection material, especially for use as radiation protection gloves and processes for their manufacture.

### BACKGROUND OF THE INVENTION

Various medical procedures require physicians and other personnel to work in areas prone to electromagnetic radiation exposure, to include exposure to X-rays, gamma-rays, and other types of radiation. For example, during many diagnostic, detection and guidance procedures, surgeons and other medical staff may work in a field of operation that is irradiated with X-rays to allow for the use of a fluoroscopic viewing screen. These personnel are thus exposed to doses of radiation that may exceed acceptable safety levels or to long-term exposure of low dosage level radiation. Radiation exposure, even to low levels of X-rays, is known to produce a number of detrimental side effects. Medical personnel who work with X-rays and X-ray equipment thus require protection from such radiation exposure with protective garments or gloves that limit or attenuate the amounts of radiation received.

Accordingly, radiation protection garments that shield specific areas of the body sensitive to such radiation exposure are well known in the art. Such garments typically include coats, aprons, gloves and various shields having radiation absorbent materials therein to attenuate the radiation. The materials used to make such garments have been made from polymer mixtures having radiation attenuating materials mixed therein. The radiation attenuating materials of prior art mixtures have comprised lead, lead oxide, or other lead salts. Such attenuating materials were used, for example, in U.S. Pat. No. 3,185,751.

U.S. Pat. No. 3,185,751, which issued to S. D. Sutton on May 25, 1965 (“the Sutton patent”), is for the manufacture of lattices, dispersions and compounds of polymeric organic material containing metal. The radiation protection material of this patent, which is used to make radiation protection gloves, comprises a middle layer of natural rubber latex containing lead particles arranged therein to attenuate the radiation intensity of scattered X-rays. The layer is formed by dipping a shaped former into a solution of matrix material followed by vulcanisation of the formed material. This layer is then covered on both sides with additional layers of material not having lead particles therein.

Although the lead particles of the Sutton patent proved effective in attenuating radiation, it has been found that lead powder promotes vulcanisation of the matrix solution in the liquid state before it has hardened. Thus, if the latex mixture has a relatively high lead content, it cannot be used for the continuous production of radiation protection gloves, as the matrix solution containing lead particles rapidly deteriorates and becomes unusable. Furthermore, the processing of lead is fundamentally undesirable for health reasons due to the fact that lead compounds are toxic materials. This toxicity may impose additional costs on the manufacture and/or user of such materials due to the required compliance with regulations relating to their handling and disposal.

Thus, there is a need for an invention that avoids the foregoing disadvantages. This invention thus arises from the task of finding a radiation protection material that is lead-free and in which radiation absorbing particles can be extremely homogeneously distributed.

### SUMMARY OF THE INVENTION

The invention provides for a radiation protection material made of a polymeric material having radiation absorbing or attenuating particles distributed therein. In one embodiment of the invention, the radiation protection material can be formed into radiation protection gloves and may comprise natural rubber latex, radiation absorbing particles, and a cellulose derivative, which by increasing the viscosity of the matrix material effectively reduces the speed of sedimentation of the radiation absorbing particles suspended therein, thereby enabling such gloves to be manufactured by a dipping process.

Commercially available prevulcanised natural rubber latex, commonly known as PV, is particularly suitable for manufacturing these radiation protection gloves as it is found to have exceptionally high latex stability and can accept a high loading of up to twice its weight of radiation protection material without the whole matrix material undergoing premature coagulation. The resulting gloves formed from this material also have adequate mechanical strength and physical properties. The radiation protection gloves, which are lead-free, comprise at least one layer of material, with multiple layers being successively formed. The radiation adsorbing particles distributed within the radiation protection material of the gloves can comprise particles of metallic tin, tin-oxide, antimony-tin oxide, bismuth oxide, tungsten oxide, or mixtures of the same. The minute particle size of these radiation absorbing particles are particularly suitable for homogeneous dispersal within the material because, as a given particle size becomes more fine, it has a slower rate of sedimentation within the matrix material.

The radiation protection material is shaped by dipping a form or pattern, e.g. a hand pattern, into coagulant and then into a solution of matrix material in a through-flow bath. Leaching, drying and preliminary finishing operations such as beading or trimming then follow. The latex products may be vulcanised in circulating hot air, steam, or hot water. Dipping, followed by vulcanisation can be repeated several times, with finishing operations to include washing and drying.

### BRIEF DESCRIPTION OF THE DRAWINGS

In the drawings:

FIG. 1 is a top view of a radiation protection glove made of one embodiment of the radiation protective material; and

FIG. 2 is a sectional view showing at least one layer of the radiation protection material of the glove;

FIG. 3 is a flow chart of one embodiment of the process of making radiation protection gloves using the radiation protection material; and

FIG. 4 is a flow chart showing one embodiment of the post treatment process of the radiation protection gloves made of the radiation protection material.

### DESCRIPTION OF THE PREFERRED EMBODIMENT

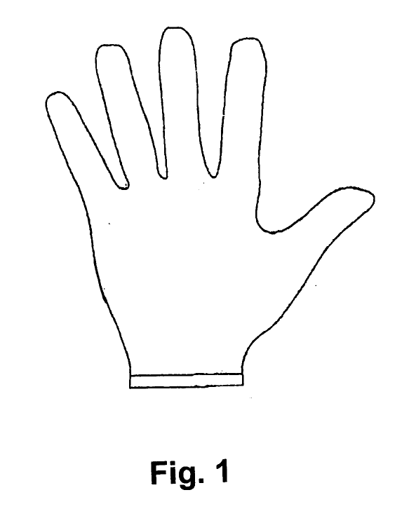

The invention provides for a radiation protection material made of at least one layer of a polymeric material having radiation absorbing or attenuating particles and a cellulose derivative distributed therein. The at least one layer of polymeric material may comprise about 20% to 40% by dry weight of rubber and about 60% to 80% by dry weight at radiation absorbing particles, preferably about 33% by dry weight of rubber and about 67% by dry weight of radiation absorbing particles. In one embodiment of the invention, the radiation protection material can be formed into radiation protection gloves, as shown in FIG. 1. The polymeric material may be a rubber material made from polyisoprene rubber, (both natural and synthetic), polybutadiene rubber, styrene-butadiene rubber, nitrile rubber, butyl rubber, ethylene-propylene rubber, neoprene rubber, silicone rubber, polysulfide rubber, urethane rubber or other similar substances.

In the preferred embodiment of the invention, natural rubber latex, a type of polyisoprene rubber produced naturally from rubber trees, is used. The natural rubber latex may contain the usual compounding ingredients such as surfactants, vulcanizing agents, activators, accelerators, antioxidants, pigments, antifoam agents and PH regulators in conventional amounts as needed to make gloves with the desired mechanical strength. Preference is given to the use of a commercially available ammoniac prevulcanised (PV) natural rubber latex where the preferred pH-value of this PV latex is greater than about 7.0, preferably about 10.0 to 11.0. The dry rubber content of this PV latex is about 50 to 70% by weight, preferably about 60% by weight, with an ammonia content between about 0.4 and 0.8% by weight, preferably about 0.6% by weight.

In addition to the radiation absorbing particles, the latex matrix mixture may also contain a cellulose derivative, such as methylcellulose (metholose) or some other water-soluble, cellulose ether. This additive, a water-soluble ether available in powder and granular forms, increases the viscosity of the matrix material mixture when dissolved and thus reduces the speed of sedimentation of the radiation absorbing particles therein. In this way, the heavy radiation absorbing particles can be held in suspension and distributed uniformly within the matrix material mixture. In one embodiment, the cellulose derivative within the at least one layer of polymeric material comprises about 0.1 to 0.4% by dry weight, preferably about 0.25% by dry weight.

In another embodiment of the mixture, natural rubber latex is used and 200 parts by dry weight of radiation absorbing particles are added to this latex containing 100 parts by dry weight of rubber (phr) and the usual compounding ingredients. The radiation absorbing particles are added to this latex compound in the form of a liquid dispersion, which in turn is prepared beforehand by ball-milling a typical composition as shown in Table 1.

TABLE 1
RADIATION ABSORBING PARTICLE DISPERSION
FORMULATION

| Material | Pbw (dry) | Wet Weight (Kg) |
|---|---|---|
| 100% Radiation Absorbing Particle | 100.00 | 100.00 |
| 20% Teric | 0.20 | 1.00 |
| 3% Metholose | 0.10 | 3.33 |
| 3% Latekoll D | 0.24 | 8.00 |
| Deionized Water | — | 23.53 |
| Total | 100.54 | 135.86 |

The typical properties of this dispersion as added to the latex compound are shown in Table 2.

TABLE 2
TYPICAL RADIATION ABSORBING PARTICLE DISPERSION
PROPERTIES

| | |
|---|---|
| TSC % | 72.0-76.0 |
| pH | Min 9.0 |
| Viscosity (cps), Spindle 3 @ 30 rpm | Min 900 |

This high mix proportion of the radiation absorbing particles to the latex compound is made possible by the addition of the methylcellulose, which in increasing the viscosity of the material mixture, reduces the sedimentation speed of the radiation absorbing particles to ensure a homogeneous distribution of the radiation absorbing particles within the mixture. In a preferred embodiment of the mixture, the composition of materials using prevulcanised natural rubber latex is as shown in Table 3.

TABLE 3
RADIATION LATEX COMPOUND FORMULATION BASED
ON PREVULCANISED NATURAL RUBBER LATEX

| Material | Phr | Wet Weight (Kg) |
|---|---|---|
| 60% Prevulcanised Natural Rubber Latex | 100.00 | 166.67 |
| (PV) | | |
| 20% Emulvin W | 0.10 | 0.50 |
| 24% Black Pigment | 0.012 | 0.05 |
| 74% Radiation Absorbing particle | 200.00 | 270.27 |
| 100% Coagulant WS | 0.20 | 0.20 |
| 3% Metolose | 0.50 | 16.67 |
| Deionized Water | — | 46.99 |
| Total | 300.812 | 501.35 |

The physical properties of this material mixture, as used to produce gloves by a dipping process, are shown in Table 4.

TABLE 4
TYPICAL RADIATION LATEX COMPOUND PROPERTIES

| | |
|---|---|
| TSC % | 56.0-62.0 |
| Ph | Min 9.0 |
| Viscosity (cps), Spindle 3 @ 30 rpm | 300-500 |

We have found that commercial prevulcanised (PV) natural rubber latex has an unusually high latex stability which makes it possible to accept a high loading of up to twice its dry rubber weight of radiation absorbing particles without affecting the overall colloidal stability of the matrix material mixture, i.e. avoiding premature coagulation. In this way, a highly homogeneous distribution of the particles is achievable with high reproducibility over extended period of time, which makes it possible to mass produce such gloves by a continuous dipping process.

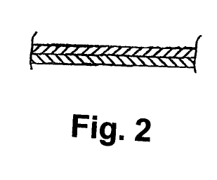

Turning to FIG. 2, the radiation protection material is lead-free and comprises at least one layer of material, with multiple layers being successively formed. The radiation protection glove can be made up of one, two or more than two layers. In the preferred embodiment of the invention, one layer is used if the final material thickness is about 0.3 mm or less. For material thicknesses of above 0.3 mm, two or more layers are used.

The radiation absorbing particles are all lead-free and can comprise bismuth alone or in combination with tungsten oxide, antimony-tin oxide and/or metallic tin. In one preferred embodiment, the radiation absorbing particles comprise about 60 to 90% by weight of metallic tin powder and about 10 to 40% by weight of bismuth oxide particles. Alternatively, the radiation absorbing particles can comprise about 60 to 90% by weight of tin oxide particles or antimony-tin oxide particles and about 10 to 40% by weight of tungsten oxide particles.

According to another possibility, the radiation absorbing particles comprise about 40 to 60% by weight of bismuth oxide particles and about 40 to 60% by weight of tungsten oxide particles. In yet a further embodiment, the radiation absorbing particles can comprise about 40 to 60% by weight of tin oxide particles or antimony-tin oxide particles, about 20 to 30% by weight of tungsten oxide particles and about 20 to 30% by weight of bismuth oxide particles.

Finally, the radiation absorbing particles can comprise about 60 to 90% by weight of tin oxide particles or antimony-tin oxide particles and about 10 to 40% by weight of bismuth oxide particles.

Other embodiments can utilize 100% of a single composition of radiation absorbing particles instead of the above percentage combinations. According to these other embodiments, the radiation absorbing particles may be comprised entirely of bismuth oxide particles, tungsten oxide particles, tin oxide particles or antimony-tin oxide particles.

The particle size of all the radiation absorbing particles (tin, tin oxide, antimony-tin oxide, bismuth oxide, tungsten oxide) are less than about 10 μm, preferably less than about 6 μm. Such particles in the Am range are particularly suitable for homogeneous dispersal in the matrix compound material mixture. Because of their minute particle size, they exhibit an especially low sedimentation speed. Furthermore, radiation-absorbing particles with a particle size under about 2 μm, preferably under about 1 μm are preferred.

The radiation protection gloves can be made by dipping processes. These processes include simple straight dipping where one or more coats of the latex material mixture are applied with no coagulant being used and the coagulant dip process, where a form is first dipped into coagulant and then into the latex material mixture. Commonly used coagulants include calcium chloride, calcium nitrate, zinc nitrate, and acetic acid.

In the preferred embodiment using the coagulant dip process, the radiation protection material is shaped by dipping a form or pattern, e.g. a hand pattern, into coagulant and then into a latex compound of matrix material in a through-flow bath. The material is typically contained in a dipping tank provided with mechanical agitation and a temperature controlled jacket. The form, which is usually aluminium, porcelain, or stainless steel, may be dipped by manual control or automatic operation. It is essential to have uniformity in immersion and withdrawal rates. Care must be taken to avoid trapping air in the mixture, which causes pinholes and blisters. After withdrawal of the form, the latex flow may be controlled in many ways, but is generally controlled by rotating the form to ensure an even distribution of the deposited latex.

Leaching, drying and preliminary finishing operations such as beading or trimming then follow. The latex products may be vulcanised in circulating hot air, steam, or hot water. If vulcanised with hot air, the vulcanisation process takes place in a through-flow oven. It is noted that vulcanisation may take place on or off the form. If cured on the form, dipping followed by vulcanisation can be repeated several times. The formed articles may be stripped wet or dry. Finishing operations include washing and drying.

In the preferred embodiment, a water dispersion of the submicron or micron-sized radiation absorbing particles is first prepared by grinding the particles in water (about 75% concentration) in a ball-miller. This dispersion is then added slowly into a prevulcanised latex emulsion (containing the rubber) with constant stirring preferably at room temperature to yield a uniform liquid compound mixture as in normal latex compounding. The latex compound mixture essentially now contains a colloidal suspension of the submicron radiation absorbing particles being non-agglomerated and uniformly dispersed. A preferred radiation protection glove comprises two lead-free layers, as illustrated in FIG. 2, that are successively formed using a matrix material compound having the composition set forth in Table 3.

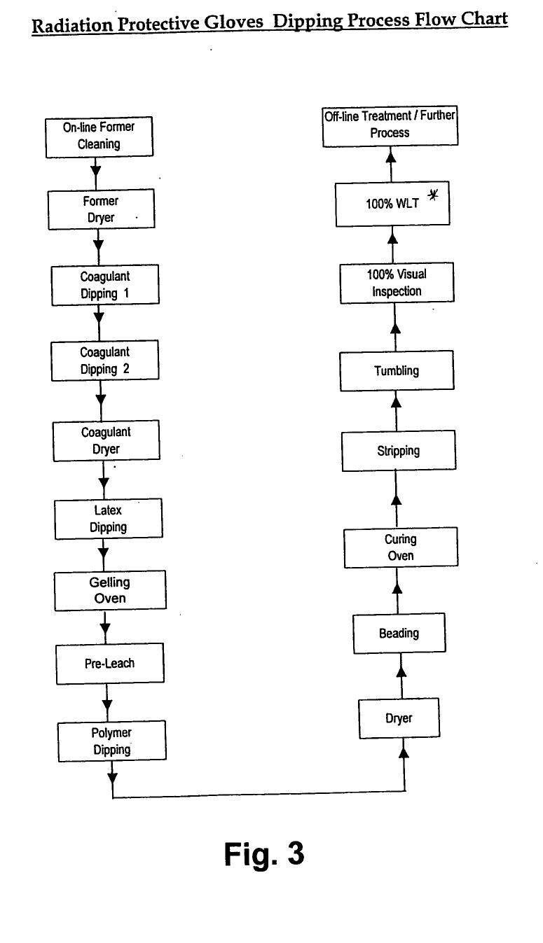

As illustrated in the flowchart of FIG. 3, for the dipping of the base radiation protection gloves, the formers are first cleaned by dipping them successively into a solution of acid-based cleaner followed by an alkaline based former cleaning agent. The formers then further go through rotating mechanical brushes followed by rinsing with clean hot water at about 70 to 80° C. to complete the cleaning. After cleaning, the formers are dried by circulating hot air in a former dryer at a temperature of about 50 to 100° C. for about 5 to 10 minutes. The formers are then dipped full length into coagulant 1 comprising about 30 to 40% calcium nitrate solution, which is then followed by dipping up to the wrist into a more dilute coagulant 2 comprising about 20 to 30% calcium nitrate solution. This double coagulant dipping feature is to ensure that the final glove produced will have uniform thickness from cuff to finger-tip.

After dipping the formers into the coagulant mixtures, they are dried in a coagulant dryer at a temperature of about 70 to 100° C. for about 5 to 10 minutes. Subsequent to drying, the formers are then dipped into the above described latex matrix compound which is stirred continuously but gently and maintained at a temperature of about 20 to 30° C. The dwell time within the latex compound is about 5 seconds while the down and up times are about 8 seconds each. The coated formers are then moved to a gelling oven where they are exposed to hot air having a temperature of about 70 to 100° C. for a time duration of about 5 minutes.

After the mixture has gelled on the formers, the coated formers undergo a pre-leaching process by immersing them in over-flowing, clean, hot water at a temperature of about 60 to 80° C. for about 3 minutes. When proleaching is complete, the coated formers are then dipped momentarily into a polymer coating solution maintained at a temperature of about 20 to 30° C. This polymer solution is a copolymer of acrylic acid and acrylic acid ester, and upon partial drying at a temperature of about 70 to 100° C. for about 3 minutes, will leave a thin polymer coating on the base glove. This polymer coating will be further bonded to the base glove upon subsequent curing of the whole glove to be described later. This polymer coating is very slick and has a lower surface friction with the human hands, which enables easy donning of the final formed glove without the need for any powder or other lubricating agents.

After partial drying, the polymer coated formers then undergo a beading process where the peripheral edges of the cuff openings of the dipped gloves are strengthened by rolling them into a solid bead (rubber band) of about 1 to 2 mm diameter. After the beading process is complete, the coated formers are then moved to a curing oven, which cures the beaded gloves by exposing them to recirculating hot air at a temperature of about 100° C. to 140° C. for about 60 to 100 minutes. When the gloves have cured, they are then manually stripped from the formers and further tumbled within a tumbler dryer at a temperature of about 70 to 90° C. for about 60 to 100 minutes to eliminate excessive powder and moisture from the gloves. This tumbling action also serves to complete curing of the gloves. The gloves thereafter undergo a 100% visual inspection for visual defects. This is followed by 100% water leak test (WLT) where the gloves are tested for pinholes/holes by filling each with about 1 litre of water and checking for leakages after about 2 minutes holding time.

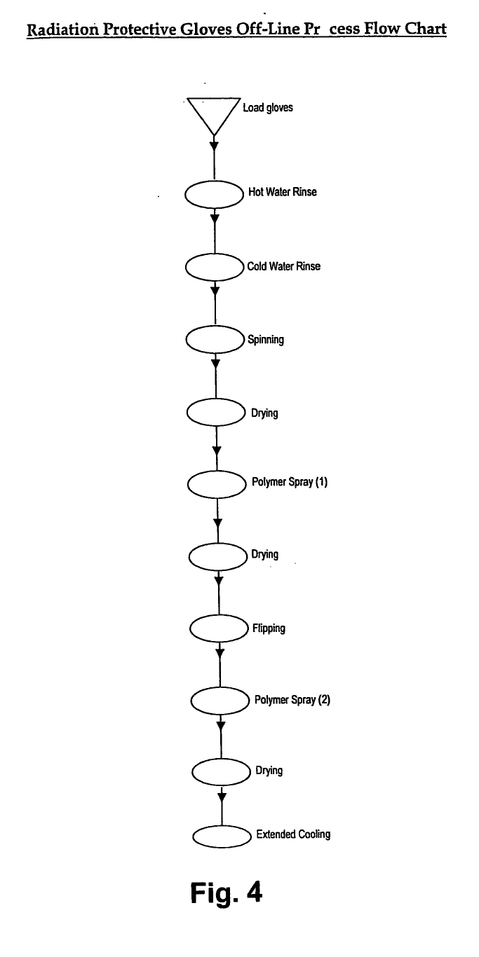

The formed gloves are further subjected to an off-line treatment/process as shown in FIG. 4, the purpose of which is to: i) convert these gloves from powdered to powder free; ii) further enhance donnability especially with damp hands; iii) impart desired “skin-grip” surface finish on working side; and iv) prevent the gloves from sticking together on both the donning and working side (after cuffing) upon storage after sterilization. In the first stage of this off-line treatment, the formed gloves are first washed batch-wise with hot water at about 60 to 90° C. for at least about 10 minutes to remove powder and non-rubbers, including proteins that are inherently present in the natural rubber from the PV latex. The gloves are then washed with unheated cold water (ambient temperature about 30° C.) for about 10 minutes. They are then spun at about 400 RPM for about 10 minutes to extract surface water before being partially dried in tumbler dryers at a temperature of about 60 to 80° C. for about 30 minutes.

After this first partial drying of the gloves with their working side outside, at least one layer of a polymer (1), which is a polyacrylate polymer, is sprayed on to the outer surface of the gloves to get the desired surface (grip) finish, to reduce a surface drag on the outer surface and also to prevent stickiness of the working side upon storage after sterilization. The gloves are dried further at about 60 to 80 IC for about 10 minutes before they are removed from the tumblers and flipped (turned inside out) to get the donning side outside and the working side inside. They are now returned to another tumbler dryer and dried at about 60 to 80° C. for at least about 30 more minutes. During this second drying, at least one layer of a polymer (2), which comprises a copolymer of an acrylic acid and an acrylic acid ester or which comprises a cationic based super-surfactant, is sprayed in so as to coat the donning side uniformly to enhance the damp hand donnability of these gloves. After drying, the gloves are then cooled down to ambient temperature and then turned over (flipped) to get the correct configuration with the donning surface inside and the working surface outside. Finally, the gloves are pair-packed and sealed before being subjected to sterilization by gamma radiation like conventional surgical gloves.

The gloves, having radiation attenuating particles distributed therein, have the radiation attenuation characteristics, as measured according to DIN 6845/1 and IEC 1331-1/ICRP 60/ICRU 51, as shown in Table 5. DIN-6815-1 is a German Standard for the “Testing of materials for radiation protection against x-rays and Gamma-rays,” with DIN being an acronym for DEUTSCHE INDUSTRIE NORM (German Industrial Standard). IEC 1331-1 (International Electro-technical Commission) is a standard of attenuation properties of materials. ICRP 60 is the 60th recommendation of the International Commission of Radiation Protection, which is the governing body on all radiation issues. ICRU 51 is the 51 st recommendation of the International Commission of Units.

TABLE 5
ATTENTUATION TEST RESULTS OF RADIATION PROTECTION
GLOVES WITH THICKNESS 0.30 mm

| Material | | | | | | | | |
|---|---|---|---|---|---|---|---|---|
| | | Radiation Absorbing | | | | | | |
| | ry rubber (% | Particle (% by weight) | | | | Attenuation Test Result | | |
| Sample | by weight) | Bi₂O₃ | WO₃ | SnO | Sn | 60 kV | 80 Kv | 100 kV |
| 1 | 33.0 | 16.7 | — | — | 50.3 | 49% | 43% | 36% |
| 2 | 33.0 | — | 16.7 | 50.3 | — | 41% | 29% | 23% |
| 3 | 33.0 | 67.0 | — | — | — | 58% | 49% | 41% |
| 4 | 33.0 | 33.5 | 33.5 | — | — | 54% | 40% | 34% |
| 5 | 33.0 | — | 67.0 | — | — | 41% | 33% | 24% |
| 6 | 33.0 | 16.7 | 16.7 | 33.5 | — | 54% | 42% | 34% |
| 7 | 33.0 | 33.5 | — | — | 33.5 | 56% | 47% | 40% |
| 8 | 33.0 | — | — | 67.0 | — | 29% | 26% | 23% |

The examples that follow describe some of these gloves which showed a maximum reduction in the radiation dose from secondary X-rays at 60 and 100 kV intensity of about 58% (60 kV) and about 41% (100 kV) respectively at a glove thickness of 0.3 mm. The equivalent lead value lies between about 0.03 and 0.04 mm Pb.

### EXAMPLE 1

Glove comprising about 33% by dry weight natural rubber (NR) with about 16.7% bismuth oxide particles and about 50.3% metallic tin particles. At 0.3 mm glove thickness, attenuation at 60kV, 80kV and 100 kV are 49%, 43% and 36%, respectively.

### EXAMPLE 2

Glove comprising about 33% by dry weight natural rubber (NR) with about 16.7% tungsten oxide and about 50.3% tin oxide. At 0.3 mm glove thickness, attenuation at 60 kV, 80 kV and 100 kV are 41%, 29% and 23%, respectively.

### EXAMPLE 3

Glove comprising about 33% by dry weight natural rubber(NR) with about 67% bismuth oxide. At 0.3 mm glove thickness, attenuation at 60 kV, 80 kV and 100 kV are 58%, 49% and 41%, respectively.

### EXAMPLE 4

Glove comprising about 33% by dry weight natural rubber (NR) with about 33.5% bismuth oxide about 33.5% tungsten oxide. At 0.3 mm glove thickness, attenuation at 60 kV, 80 kV and 100 kV are 54%, 40% and 34%, respectively.

### EXAMPLE 5

Glove comprising about 33% by dry weight natural rubber (NR) with about 67% tungsten oxide. At 0.3 mm glove thickness, attenuation at 60 kV, 80 kV and 100 kV are 41%, 33% and 24%, respectively.

### EXAMPLE 6

Glove comprising about 33% by dry weight natural rubber (NR) with about 16.7% bismuth oxide, about 16.7% tungsten oxide and about 33.5% tin oxide. At 0.3 mm glove thickness, attenuation at 60 kV, 80 kV and 100 kV are 54%, 42% and 34%, respectively.

### EXAMPLE 7

Glove comprising about 33% by dry weight natural rubber (NR) with about 33.5% bismuth oxide and about 33.5% metallic tin. At 0.3 mm glove thickness, attenuation at 60 kV, 80 kV and 100 kV are 56%, 47% and 40%, respectively.

### EXAMPLE 8

Glove comprising about 33% by dry weight natural rubber (NR) with about 67% tin oxide. At 0.3 mm glove thickness, attenuation at 60 kV, 80 kV and 100 kV are 29%, 26% and 23%, respectively.

The foregoing description, examples and accompanying figures are illustrative of the present invention. Still other variations and are possible without departing from the spirit and scope of this invention.

What is claimed is:

1. A radiation protection material for use in radiation protection gloves comprising: at least one layer of a polymeric material of rubber having radiation absorbing particles and a cellulose derivative distributed therein, the radiation absorbing particles attenuating the intensity of scattered radiation.

2. The radiation protection material of claim 1 wherein the at least one layer of polymeric material comprises about 20 to 40% by dry weight of rubber and about 60 to 80% by dry weight of radiation absorbing particles.

3. The radiation protection material of claim 2 wherein the cellulose derivative comprises about 0.1 to 0.4% by dry weight.

4. The radiation protection of claim 1 wherein the at least one layer of polymeric material comprises about 33% by dry weight of rubber and about 67% by dry weight of radiation absorbing particles.

5. The radiation protection material of claim 4 wherein the cellulose derivative comprises about 0.25% by dry weight.

6. The radiation protection material of claim 4 wherein the cellulose derivative comprises a water-soluble cellulose ether.

7. The radiation protection material of claim 4 wherein the water-soluble cellulose ether comprises methylcellulose.

8. The radiation protection material of claim 4 wherein the radiation absorbing particles comprise about 100% by weight of bismuth oxide particles.

9. The radiation protection material of claim 4 wherein the radiation absorbing particles comprise about 100% by weight of tungsten oxide particles.

10. The radiation protection material of claim 4 wherein the radiation absorbing particles comprise about 100% by weight of tin oxide particles.

11. The radiation protection material of claim 4 wherein the radiation absorbing particles comprise about 100% by weight of antimony-tin oxide particles.

12. The radiation protection material of claim 4 wherein the radiation absorbing particles comprise about 60 to 90% by weight metallic tin particles and about 10 to 40% by weight of bismuth oxide particles.

13. The radiation protection material of claim 4 wherein the radiation absorbing particles comprise about 60 to 90% by weight of tin oxide particles and about 10 to 40% by weight of tungsten oxide particles.

14. The radiation protection material of claim 4 wherein the radiation absorbing particles comprise about 60 to 90% by weight of antimony-tin oxide particles and about 10 to 40% by weight of tungsten oxide particles.

15. The radiation protection material of claim 4 wherein the radiation absorbing particles comprise about 40 to 60% by weight of bismuth oxide particles and about 40 to 60% by weight of tungsten oxide particles.

16. The radiation protection material of claim 4 wherein the radiation absorbing particles comprise about 40 to 60% by weight of tin oxide, about 20 to 30% by weight of tungsten oxide particles, and about 20 to 30% by weight of bismuth oxide particles.

17. The radiation protection material of claim 4 wherein the radiation absorbing particles comprise about 40 to 60% by weight of antimony-tin oxide particles, about 20 to 30% by weight of tungsten oxide particles, and about 20 to 30% by weight of bismuth oxide particles.

18. The radiation protection material of claim 4 wherein the radiation absorbing particles comprise about 60 to 90% by weight of tin oxide particles and about 10 to 40% by weight of bismuth oxide particles.

19. The radiation protection material of claim 4 wherein the radiation absorbing particles comprise about 60 to 90% by weight of antimony-tin oxide particles and about 10 to 40% of bismuth oxide particle.

20. The radiation material of claim 4 wherein the at least one layer of polymeric material is formed by dipping a pattern into the material and vulcanising the material on the pattern.

21. The radiation protection material of claim 4 wherein the polymeric material comprises a rubber material.

22. The radiation protection material of claim 21 wherein the rubber material is selected from the group consisting of polyisoprene rubber, polybutadiene rubber, styrene-butadiene rubber, nitrile rubber, butyl rubber, ethylene-propylene rubber, neoprene rubber, silicone rubber, polysulfide rubber and urethane rubber.

23. The radiation protection material of claim 22 wherein the polyisoprene rubber is comprised of a natural rubber latex.

24. The radiation protection material of claim 23 wherein the natural rubber latex comprises about 60% by dry weight of rubber and about 0.4 to 0.8% by weight of ammonia prior to a vulcanisation of the material.

25. The radiation protection material of claim 23 wherein the natural rubber latex is a prevulcanised natural rubber latex having a pH-value of greater than about 10 to 11.

26. The radiation protection material of claim 4 wherein the at least one layer of polymeric material comprises at least two layers.

27. The radiation protection material of claim 4 further comprising at least one layer of a polymer coating on an inner that reduces a surface friction of the inner surface of the radiation protection material with respect to hands.

28. The radiation protection material of claim 27 wherein the at least one layer of polymer coating comprises a copolymer of an acrylic acid and an acrylic acid ester.

29. The radiation protection material of claim 27 further comprising at least one layer of a cationic-based super-surfactant to improve the lubricity and donnability of the gloves with respect to damp hands.

30. The radiation protection material of claim 4 further comprising at least one layer of a polymer coating on an outer surface of the at least one layer of material that reduces a stickiness of the surface.

31. The radiation protection material of claim 30 wherein the at least one layer of polymer coating reduces a surface drag of the outer surface.

32. The radiation protection material of claim 30 wherein the at least one layer of polymer coating material comprises a polyacrylate.

33. The radiation protection material of claim 4 wherein the radiation absorbing particles have a particle size of less than about 10μm.

34. The radiation protection material of claim 3 wherein the radiation absorbing particles have a particle size of less than about 6 μm.

35. The radiation protection material of claim 3 wherein the radiation absorbing particles have a particle size of less than about 2 μm.
